(19) United States
(12) Patent Application Publication
(10) Pub. No.: US 2025/0291124 A1
(43) Pub. Date: Sep. 18, 2025

(54) DETACHABLE HYBRID FIBER AND CONDUCTIVE CONNECTOR

(71) Applicant: Panduit Corp., Tinley Park, IL (US)

(72) Inventors: Ryan N. Murphy, Monee, IL (US); Bulent Kose, Burr Ridge, IL (US); Yu Huang, Orland Park, IL (US); Jose M. Castro, Naperville, IL (US)

(73) Assignee: Panduit Corp., Tinley Park, IL (US)

(21) Appl. No.: 19/047,009

(22) Filed: Feb. 6, 2025

Related U.S. Application Data
(60) Provisional application No. 63/565,605, filed on Mar. 15, 2024.

(51) Int. Cl. G02B 6/38; H01R 13/627; H01R 31/06

(52) U.S. Cl. CPC G02B 6/3817; G02B 6/3825; H01R 13/627; H01R 31/06

(57) ABSTRACT

A hybrid connector assembly system for providing data communications via both fiber and copper wires while utilizing a compact form factor is provided.

### CROSS-REFERENCE TO RELATED APPLICATION(S)

This application claims benefit to U.S. Provisional Patent Application No. 63/565,605, filed Mar. 15, 2024, the entirety of which is hereby incorporated by reference herein.

### TECHNICAL FIELD

The present disclosure relates to hybrid optical fiber and electrical conductor connector assemblies that include components that are attachable and detachable from the existing fiber optic components in the connector.

### BACKGROUND

Conventional connectors often specialize in either electrical power transmission or optical data communication, necessitating the use of multiple connectors and cables to cater to diverse functionalities in various applications. In numerous industries and application scenarios, the demand for streamlined and versatile connector solutions has been steadily increasing. Recognizing these evolving needs, the hybrid connector emerges as a pioneering solution, adeptly surmounting the limitations of traditional connectors. This innovative connector seamlessly integrates the capabilities of transmitting electric power and optical data over a unified connector interface. This amalgamation of power delivery and data communication within a single hybrid connector presents a myriad of compelling advantages. First and foremost, it substantially reduces installation costs, as it obviates the requirement for multiple connectors, intricate cabling, and the associated installation complexities. Moreover, it simplifies the infrastructure, leading to tidier and more efficient cable management. The versatility it brings to system design is yet another boon, granting engineers and designers enhanced flexibility to tailor systems to specific needs and constraints. The applicability of such a connector extends to a wide array of sectors, particularly in scenarios where both electrical power delivery and high-speed data communication are indispensable. These encompass but are not limited to cutting-edge domains like smart grid systems, industrial automation, data centers, and telecommunications networks.

Existing hybrid connectors are bulky and complicated to manufacture. Therefore, it is desirable to develop a compact hybrid connector. Moreover, if an electrical connector and adapter can be attached to and detached from the existing fiber optic connector and fiber optic adaptor, it will save material and cost and bring flexibility to the installation. A field terminable fiber optic connector features a stub fiber with one pre-polished end, allowing for rapid assembly with a field fiber, resulting in the swift creation of a fiber optic connector.

### SUMMARY

According to one non-limiting exemplary embodiment of the present disclosure, a hybrid fiber and copper connector and adapter system containing LC type fiber optic connectors and a LC fiber optic adapter is provided, wherein the fiber optic connectors can be connected to each other via the fiber optic adapter, wherein the system contains an electrical adaptor that can be attached to and detached from the fiber optic adapter via snap-fit or other mechanical methods, wherein the system contains electrical connectors that can be attached to and detached from the fiber optic connectors via push-pull clips or other mechanical methods, wherein the electrical adaptor can be electrically connected to the electrical connectors, wherein the electrical connectors can be electrically connected to electrical wires of cables.

In such a hybrid fiber and copper connector and adapter system, the electrical adapter may be a power receptacle containing a double-sided pin contact plug, the electrical connectors may be power plug housings containing crimp contact receptacles, the fiber optic connector may feature a stub fiber with one pre-polished end at the fiber optic connector's endface, while the stub fiber's other end may be seamlessly connected to a field fiber to install a fiber optic connector on a fiber optic cable, the hybrid fiber and copper connector and adapter system may be installed in a patch panel, or the hybrid fiber and copper connector and adapter system may be installed in a cassette.

According to another non-limiting exemplary embodiment of the present disclosure, a hybrid fiber and copper connector and adapter system containing SC, CS, SN, FC, ST, MTP/MPO, or other type of fiber optic connectors and a corresponding fiber optic adapter is provided, wherein the fiber optic connectors can be connected to each other via the fiber optic adapter, wherein the system contains an electrical adaptor that can be attached to and detached from the fiber optic adapter via snap-fit or other mechanical methods, wherein the system contains electrical connectors that can be attached to and detached from the fiber optic connectors via push-pull clips or other mechanical methods, wherein the electrical adaptor can be electrically connected to the electrical connectors, wherein the electrical connectors can be electrically connected to electrical wires of cables.

In such a hybrid fiber and copper connector and adapter system, the electrical adapter may be a power receptacle containing a double-sided pin contact plug, the electrical connectors may be power plug housings containing crimp contact receptacle, the fiber optic connector may feature a stub fiber with one pre-polished end at the fiber optic connector's endface, while the stub fiber's other end can be seamlessly connected to a field fiber to install a fiber optic connector on a fiber optic cable, the hybrid fiber and copper connector and adapter system may be installed in a patch panel, the hybrid fiber and copper connector and adapter system may be installed in a cassette, the hybrid fiber and copper connector and adapter system may be installed in a work area outlet, or the hybrid fiber and copper connector and adapter system may be installed in a work area outlet.

A detailed description of this and other non-limiting exemplary embodiments of a hybrid connector and method for manufacturing and using such hybrid connector is set forth below together with the accompanying drawings.

### BRIEF DESCRIPTION OF THE DRAWINGS

FIG. 1A illustrates a perspective view of a hybrid connector assembly system, according to a non-limiting exemplary embodiment of the present disclosure.

FIG. 1B illustrates a side view of the hybrid connector assembly system shown in FIG. 1A, according to a non-limiting exemplary embodiment of the present disclosure.

FIG. 2A illustrates a perspective exploded view of the hybrid connector assembly system shown in FIG. 1A, according to a non-limiting exemplary embodiment of the present disclosure.

FIG. 2B illustrates a side exploded view of the hybrid connector assembly system shown in FIG. 1B, according to a non-limiting exemplary embodiment of the present disclosure.

FIG. 3 illustrates a head-on front-side view of a hybrid connector included in the hybrid connector assembly system shown in FIG. 1A, according to a non-limiting exemplary embodiment of the present disclosure.

FIG. 4 illustrates a sectional view taken along the sectional line 4-4 from the hybrid connector shown in FIG. 3, according to a non-limiting exemplary embodiment of the present disclosure.

FIG. 5 illustrates an exploded perspective view of a hybrid connector included in the hybrid connector assembly system shown in FIG. 1A, according to a non-limiting exemplary embodiment of the present disclosure.

FIG. 6 illustrates an exploded perspective view of a power plug clip attaching to a portion of the hybrid connector shown in FIG. 5, according to a non-limiting exemplary embodiment of the present disclosure.

FIG. 7A illustrates a perspective view showing a first side of an adapter assembly included in the hybrid connector assembly system shown in FIG. 1A, according to a non-limiting exemplary embodiment of the present disclosure.

FIG. 7B illustrates a perspective view showing a second side of the adapter assembly included in the hybrid connector assembly system shown in FIG. 1A, according to a non-limiting exemplary embodiment of the present disclosure.

FIG. 8 illustrates a perspective view of a connector adapter assembly and a power receptacle included in the hybrid connector assembly system shown in FIG. 1A, according to a non-limiting exemplary embodiment of the present disclosure.

FIG. 9 illustrates an exploded perspective view of a connector adapter assembly and a power receptacle included in the hybrid connector assembly system shown in FIG. 1A. This exploded view shows certain internal components of the adapter assembly and the power receptacle, according to a non-limiting exemplary embodiment of the present disclosure.

FIG. 10A illustrates a first perspective view of the power receptacle shown in FIG. 8, according to a non-limiting exemplary embodiment of the present disclosure.

FIG. 10B illustrates a second perspective view of the power receptacle shown in FIG. 8, according to a non-limiting exemplary embodiment of the present disclosure.

FIG. 11A illustrates a head on front-side view of the power receptacle shown in FIG. 8, according to a non-limiting exemplary embodiment of the present disclosure.

FIG. 11B illustrates a section view taken along a sectional line 12B-12B of the power receptacle shown in FIG. 11A, according to a non-limiting exemplary embodiment of the present disclosure.

FIG. 12A illustrates a first perspective view of an alternative hybrid connector assembly system, according to a non-limiting exemplary embodiment of the present disclosure.

FIG. 12B illustrates a second perspective view of the alternative hybrid connector assembly system shown in FIG. 12A, according to a non-limiting exemplary embodiment of the present disclosure.

FIG. 13 illustrates an exploded perspective view of the alternative hybrid connector assembly system shown in FIG. 12A, according to a non-limiting exemplary embodiment of the present disclosure.

FIG. 14A illustrates a first perspective view of a connector adapter assembly and an alternative power receptacle included in the alternative hybrid connector assembly system, according to a non-limiting exemplary embodiment of the present disclosure.

FIG. 14B illustrates a second perspective view of the connector adapter assembly and the alternative power receptacle included in the alternative hybrid connector assembly system, according to a non-limiting exemplary embodiment of the present disclosure.

FIG. 15A illustrates an exploded first perspective view of the alternative power receptacle, the exploded view showing certain internal components of the alternative power receptacle, according to a non-limiting exemplary embodiment of the present disclosure.

FIG. 15B illustrates an exploded second perspective view of the alternative power receptacle, the exploded view showing certain internal components of the alternative power receptacle, according to a non-limiting exemplary embodiment of the present disclosure.

FIG. 16A illustrates a head on front-side view of the alternative power receptacle shown in FIG. 14A, according to a non-limiting exemplary embodiment of the present disclosure.

FIG. 16B illustrates a section view taken along the sectional line 16B-16B of the alternative power receptacle shown in FIG. 16A, according to a non-limiting exemplary embodiment of the present disclosure.

### DETAILED DESCRIPTION

Detailed non-limiting embodiments of a hybrid connector assembly system are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

Described herein is a novel hybrid connector assembly system that includes both a hybrid connector, a connector adapter assembly, and a power receptacle for transmitting both data over optical fiber and power over an electrically conductive wire.

This disclosure describes a method and a system to attach a power transmission system to an existing fiber optic connector and adapter system (e.g., LC connector and adapter). For exemplary purposes, the LC form factor will be referenced. However, the method and system disclosed here can be applied to many different types of duplex connectors, such as SC, FC, ST, CS and SN, and also to parallel fiber optic connectors such as MTP/MPO. The embodiments described here are fully field terminable, but the disclosed solution can also be applied to factory terminated connectors. So, this solution shows and utilizes an existing LC fiber optic connector housing that has been modified, but other versions of this invention could be applied to completely unmodified LC adapter housings.

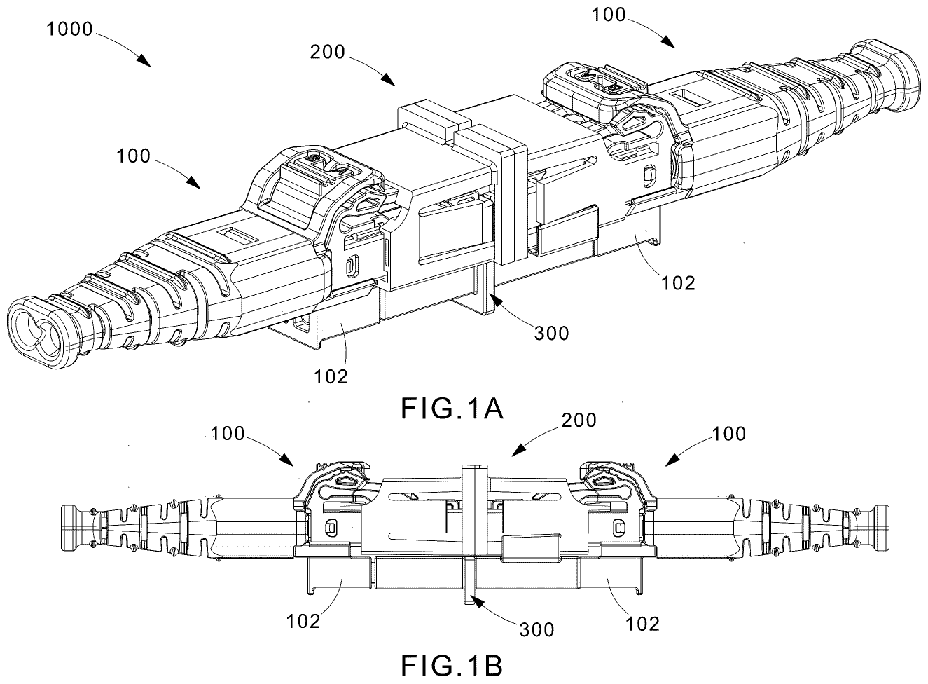

FIG. 1A shows a perspective view of an exemplary hybrid connector assembly system 1000 in an assembled state, where the hybrid connector assembly system 1000 includes a connector adapter assembly 200, a hybrid connector 100 installed into one side of the connector adapter assembly 200, and another hybrid connector 100 installed into an opposite side of the connector adapter assembly 200. The two hybrid connectors 100 may share the same design and components, and a corresponding power plug clip 102 is attached to a bottom of each hybrid connector 100. The hybrid connector assembly system 1000 also includes a power receptacle 300 attached to a portion of the connector adapter assembly 200. FIG. 1B shows a side view of the hybrid connector assembly system 1000.

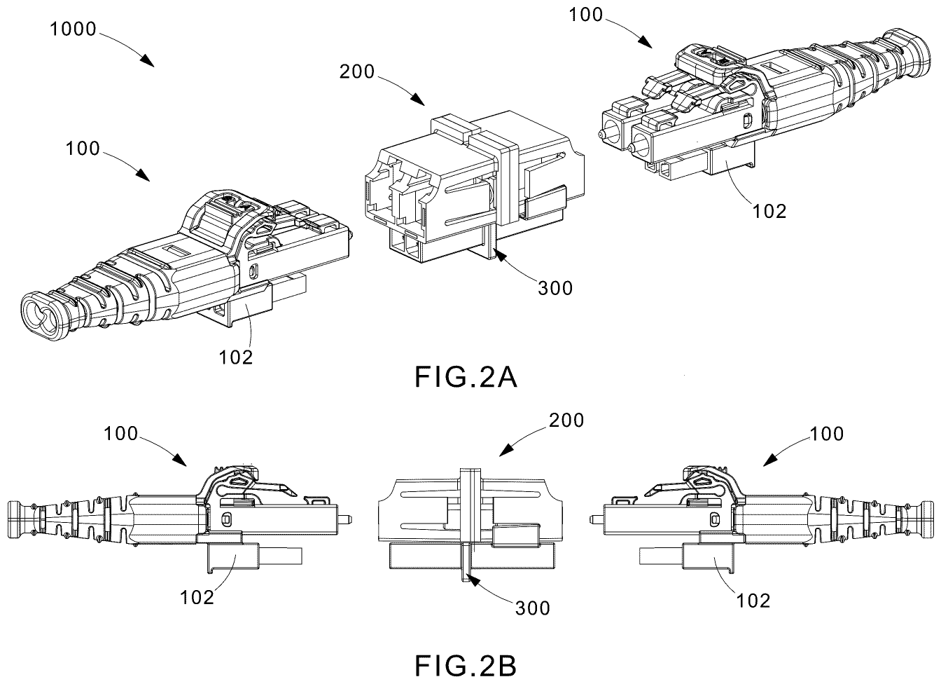

FIG. 2A shows an exploded perspective view of the hybrid connector assembly system 1000 shown in FIG. 1A, and FIG. 2B shows an exploded side view of the hybrid connector assembly system 1000 shown in FIG. 1B.

Connectors in existing LC connector/adapter systems may utilize a push-pull clip. This clip typically serves two functions, the first being to join and retain two LC fiber optic connectors together in a side-by-side fashion, and the second to simultaneously release both LC fiber optic connectors from the LC fiber optic adapter. In the present hybrid connector assembly system 1000, the power plug clip 102 is taking on the function of this push-pull clip, while additionally being modified to include a power plug housing for transmitting power over an electrically conductive wire. So, the power plug clip 102 now includes the power plug housing molded into the bottom of the part to facilitate electrical power transmission via crimp receptacle contacts 106 housed within the power plug housing.

The purpose of the crimp receptacle contacts 106 is to retain the conductive wire 10 and facilitate an electrical connection through the power plug clip 102 and into the power receptacle 300. The crimp receptacle contacts 106 may be a stamped sheet metal part that is made from plated copper, which is a good electrical conductor, or other conductive material. To retain the conductive wire 10, the conductive wire 10 may be inserted into the wire insertion/crimp area and a crimp tool may be used to collapse the crimp receptacle contacts 106 onto the wire. Next, the crimp receptacle contacts 106 is inserted into the rear of the power plug clip 102, where a feature in the housing of the power plug clip 102 retains the crimp receptacle contacts 106 via the locking lance.

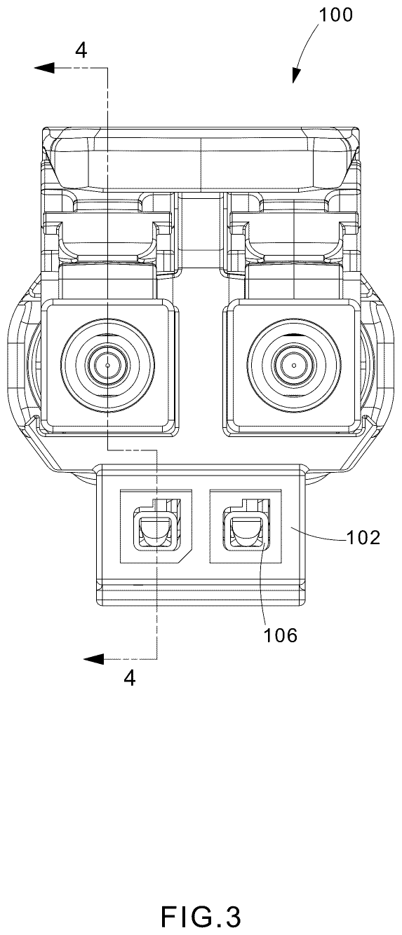

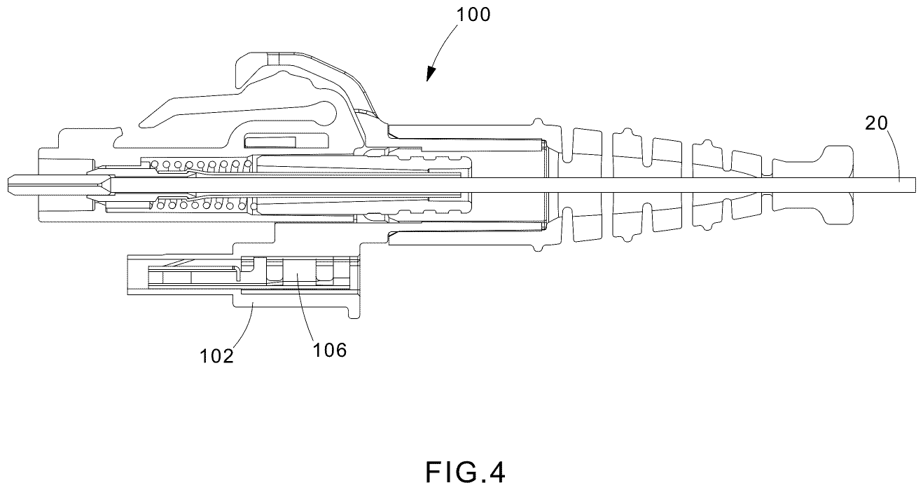

As shown in FIG. 3 and the sectional view shown in FIG. 4, the crimp receptacle contacts 106 are housed within the power plug housing located at a rear of the power plug clip 102, and the crimp receptacle contacts 106 are configured to secure/crimp down onto ends of conductive wires fed through the rear of the power plug clip 102. The crimp receptacle contacts 106 are female gendered and mechanically retained inside the power plug housing via locking lances or some other similar securing mechanism method.

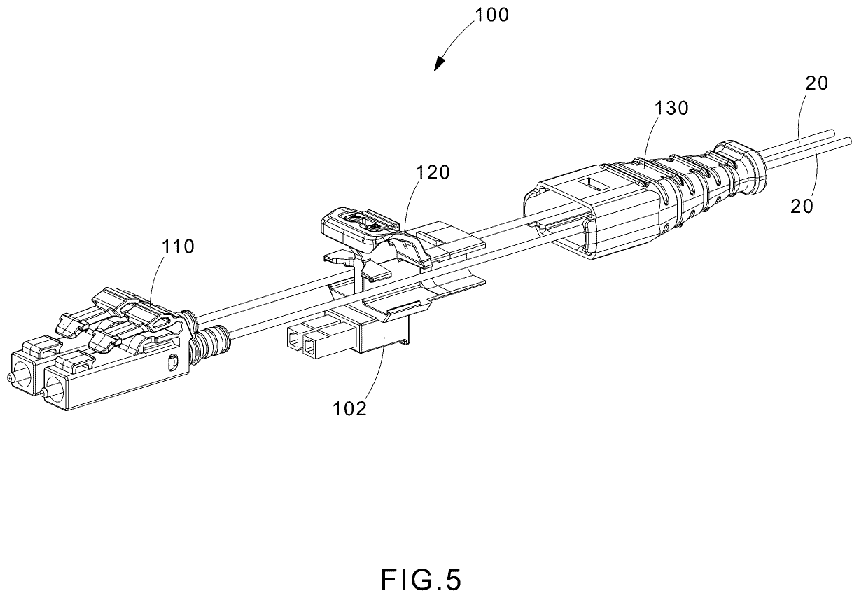

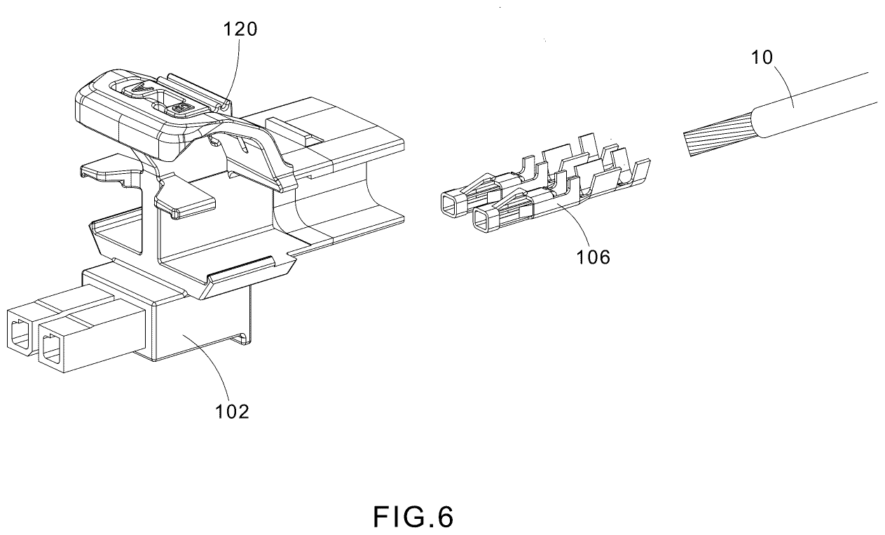

FIG. 5 illustrates an exploded view of the hybrid connector 100 that includes a front housing 110, a mid housing 120, and a boot 130. Optical fibers 20 are shown to be routed through the hybrid connector 100. The power plug clip 102 is shown to be a part of the mid housing 120 of the hybrid connector 100. FIG. 6 shows a more detailed view of the crimp receptacle contacts 106 that are installed into the duplex openings of the power plug clip 102 for coupling to the conductor wire 10. The conductor wire 10 is shown to include an insulation outer jacket and an inner conductor.

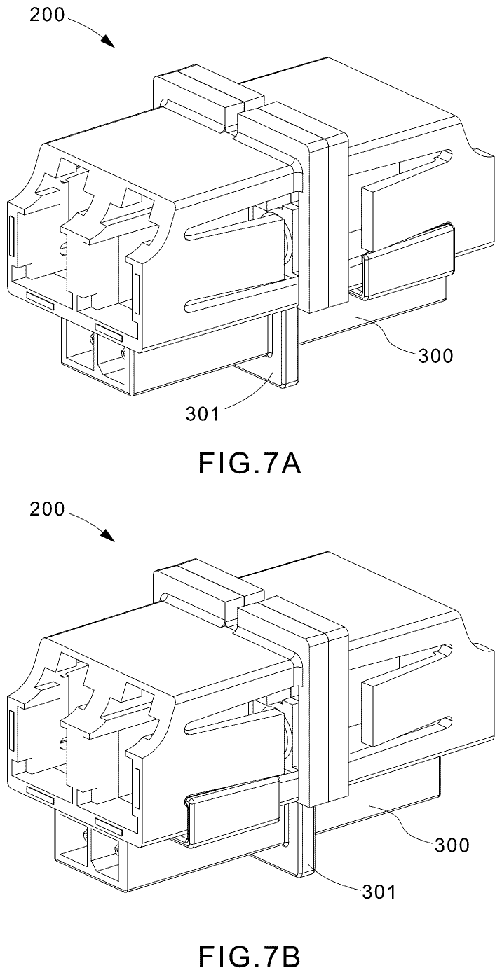

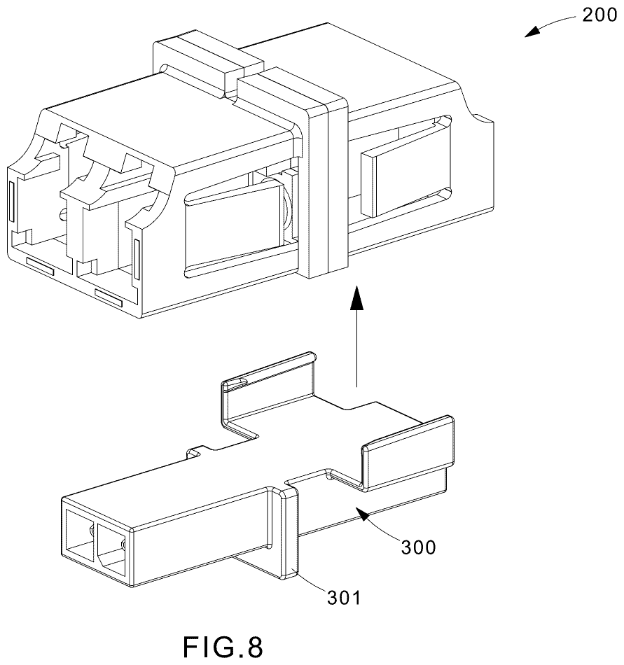

FIG. 7A shows a perspective view of a first side to the connector adapter assembly 200, and 7B shows a perspective view of a second side to the connector adapter assembly 200, where the power receptacle 300 is attached to a lower portion of the connector adapter assembly 200. FIG. 8 illustrates a perspective view showing how the power receptacle 300 attaches to the connector adapter assembly 200, where an off-center flange 301 for the power receptacle 300 can be seen. This design of the power receptacle 300 enables it to attach to the bottom of the connector adapter assembly 200 while passing through an opening in a fiber optic management system such as a patch panel. The off-center flange 301 is positioned to contact the patch panel.

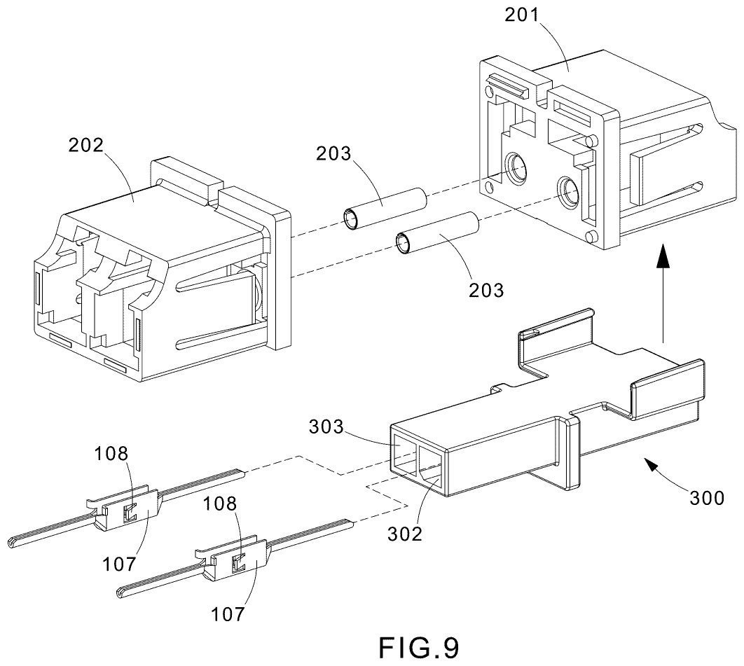

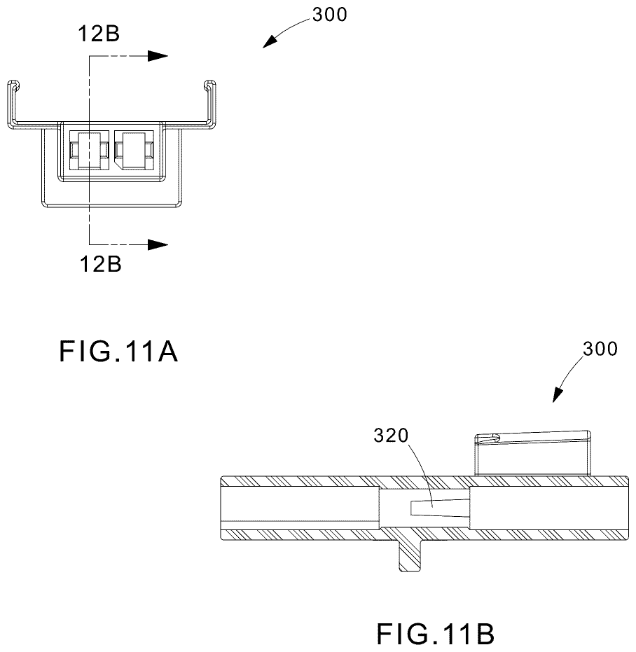

FIG. 9 shows an exploded view of the connector adapter assembly 200 to illustrate how the connector adapter assembly 200 is comprised of a first half 201 and a second half 202, as well as certain internal components such as sleeves 203 for carrying optical fibers through from the first half 201 to the second half 202. FIG. 9 also shows double sided pin contacts 107 that fit inside the power receptacle 300, and where the double sided pin contacts 107 include latches 108 for securing with locking features 320 inside the channels 302, 303 of the power receptacle 300. The locking features 320 are shown in FIG. 11B, where FIG. 11B shows a sectional view taken along a sectional line 11B-11B of the power receptacle 300 shown in FIG. 11A. The locking features 320 may be a locking lance and flat surface stop features that are used to retain the double sided pin contacts 107 inside their respective channels 302, 303.

The purpose of the double sided pin contacts 107 is to facilitate an electrical connection through the power receptacle 300 and into each power plug clip 102. The double sided pin contacts 107 are a stamped sheet metal part that is made from copper or plated copper, which is a good electrical conductor. The double sided pin contacts 107 are inserted into the end of the power receptacle 300 that is opposite the snap-fit features, and with the flanges on the double sided pin contacts 107 oriented on the side farthest from the connector adapter assembly 200. The double sided pin contacts 107 are mechanically retained inside the housing of the connector adapter assembly 200 via the features inside the housing, and the flanges and locking lances on the double sided pin contacts 107. The locking lances spring into a feature inside the housing while the flanges rest on a surface stop feature inside the housing. The flanges prevent the double sided pin contacts 107 from translating forward any further and the locking lances prevent it from pulling out. The doubled sided nature of the pin contacts 107 allows for an electrical connection on each side and facilitates electrical conductivity throughout the power receptacle 300.

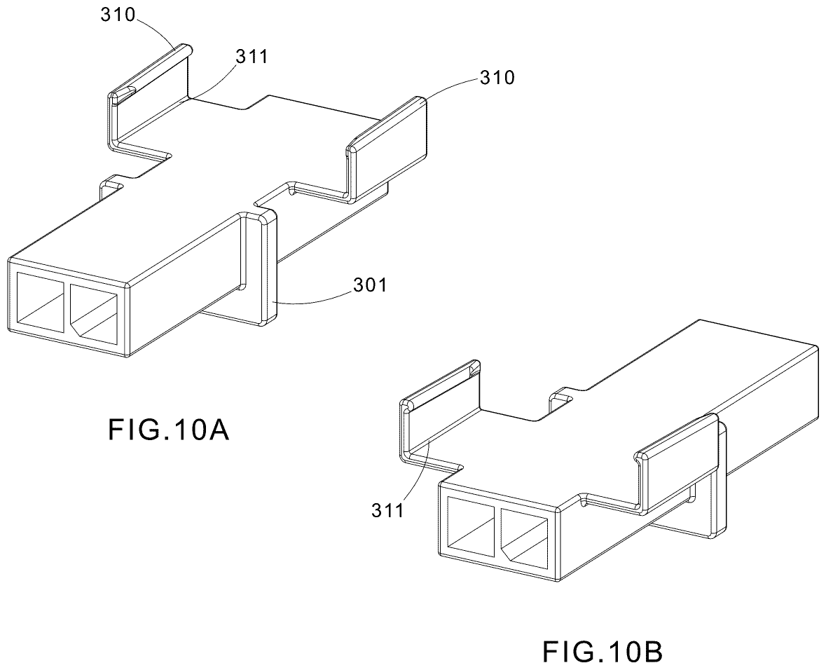

As seen in FIGS. 10A and 10B, the power receptacle 300 includes two cantilever beam type snap-fit features 311 for retainment onto the connector adapter assembly 200. The front sides of the snap-fit features 311 are ramped towards the adapters to aid with installation. The power receptacle 300 is asymmetrical in length about the off-center flange 301 center-front plane to accommodate for the asymmetrical nature that an LC adapter mounts into a patch panel. The two double sided pin contacts 107 are installed inside their respective channels 302, 303. The pin/plug contacts are male gendered and mechanically retained inside the receptacle housing via locking lances or some other method.

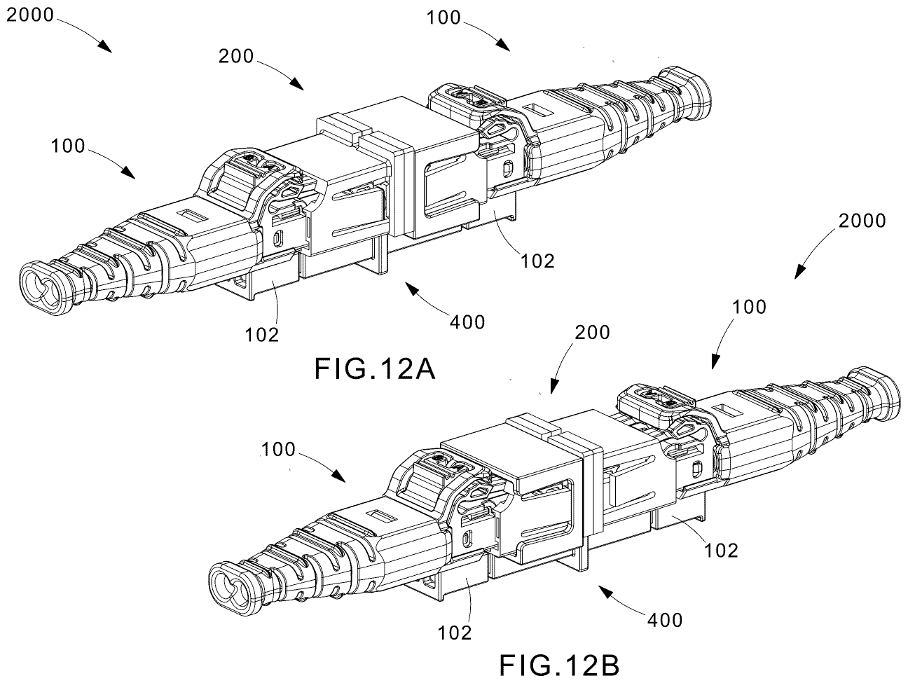

An alternative embodiment of the power receptacle 400 is shown in FIGS. 12A-16B. The alternative power receptacle 400 fits onto the same connector adapter assembly 200 as described previously. However, the power receptacle 400 is designed to encircle the entire connector adapter assembly 200 for support, as shown in FIGS. 12A and 12B. In the hybrid connector assembly system 2000, the alternative design for the power receptacle 400 is used, and can be seen to encircle the connector adapter assembly 200. In this embodiment of the hybrid connector assembly system 2000 including the power receptacle 400, the unused patch panel latches on the connector adapter assembly 200 can be used to retain the power receptacle 400.

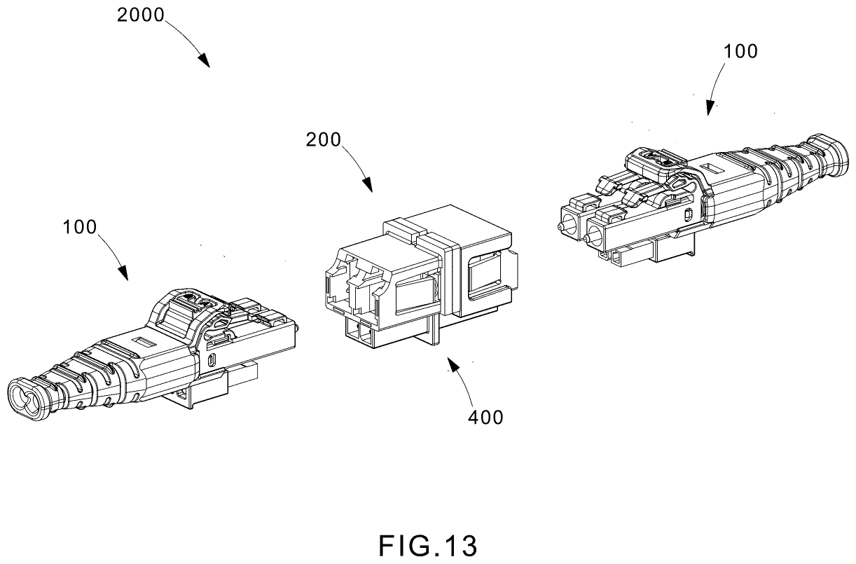

FIG. 13 shows an exploded perspective view of the power receptacle 400, displaying how the same hybrid connectors 100 may fit into the connector adapter assembly 200 having the power receptacle 400 attached.

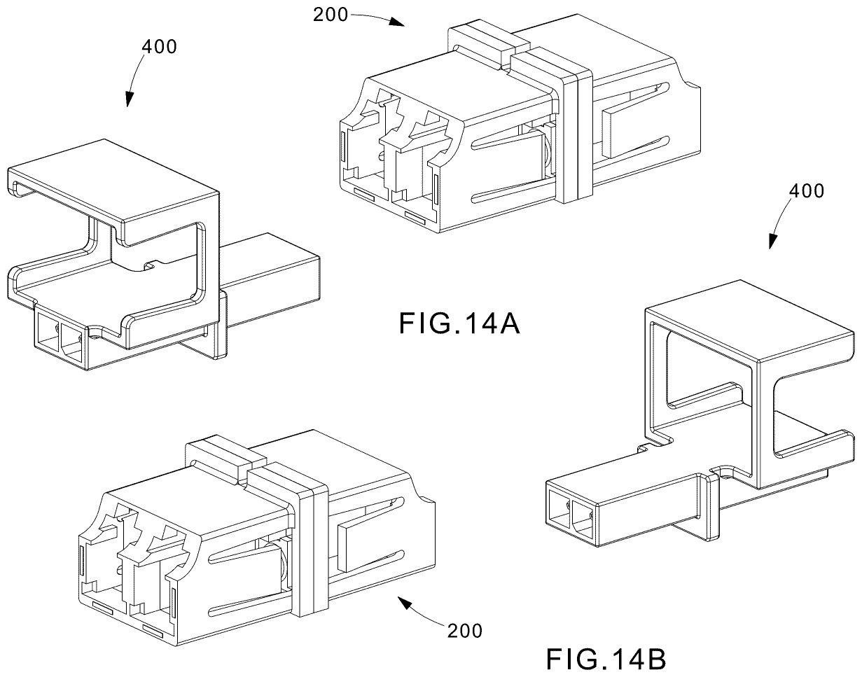

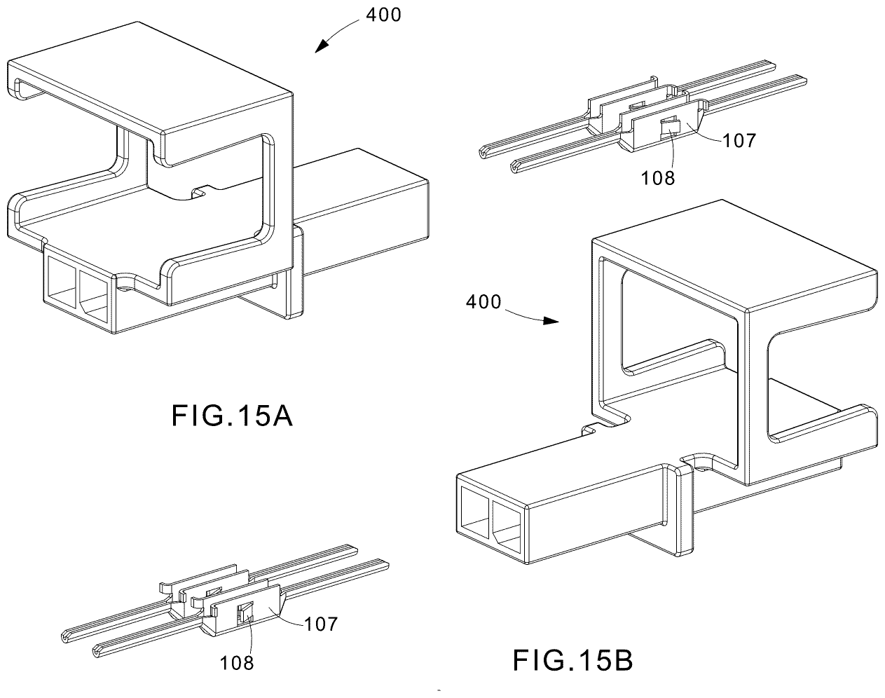

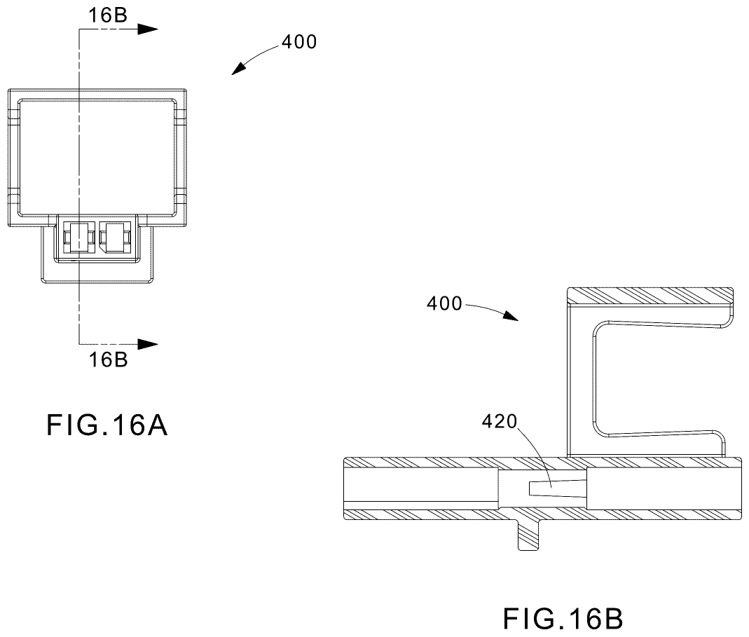

FIGS. 14A and 14B show perspective views of the two sides to the power receptacle 400, where instead of merely having clips for attaching to the connector adapter assembly 200, the power receptacle 400 now includes a structured opening for entirely encircling the connector adapter assembly 200 for installation attachment. FIGS. 15A and 15B show that the power receptacle 400 may include the same two double sided pin contacts 107 that are installed inside their respective channels of the power receptacle 400. The double sided pin contacts 107 also include the same latches 108 for securing with locking features 420 inside their respective channels, where the locking features 420 are shown in the sectional view of the power receptacle 400 in FIG. 16B that takes the sectional view along a sectional line 16B-16B included in the power receptacle 400 illustrated in FIG. 16A.

As is readily apparent from the foregoing, various non-limiting exemplary embodiments of a hybrid connector assembly system have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A hybrid connector assembly system comprising:
a first hybrid connector including a first fiber connector and a first power plug;
a second hybrid connector including a second fiber connector and a second power plug; and
a hybrid adapter comprising:
a first side fiber receptacle;
a second side fiber receptacle; and
an electrical adapter including a first side power receptacle and a second side power receptacle, wherein when the first fiber connector is installed into the first side fiber receptacle and the second fiber connector is installed into the second side fiber receptacle, the first fiber connector is coupled to the second fiber connector via the hybrid adapter to transfer data, and wherein when the first power plug is installed into the first side power receptacle and the second power plug is installed into the second side power receptacle, the first power plug is electrically coupled to the second power plug via the hybrid adapter to transfer electrical power.

2. The hybrid connector assembly system of claim 1, wherein the electrical adapter is removably attached to the hybrid adapter.

3. The hybrid connector assembly system of claim 1, wherein the electrical adapter is removably attached to the hybrid adapter via a snap-fit mechanism.

4. The hybrid connector assembly system of claim 1, wherein the electrical adapter is removably attached to the hybrid adapter via a push-pull clip mechanism.

5. The hybrid connector assembly system of claim 1, the electrical adapter further comprising:
a double-sided pin contact plug.

6. The hybrid connector assembly system of claim 1, the first power plug including a first crimp receptacle contact and the second power plug including a second crimp receptacle contact.

7. The hybrid connector assembly system of claim 1, wherein the first fiber connector is configured to include one of an LC, CS, MPO, SN, SC, or ST fiber connector form factor.

8. The hybrid connector assembly system of claim 1, the first hybrid connector comprising:
a front housing, the first fiber connector included in the front housing;
a mid housing, the first power plug included in the mid housing; and
a boot.

9. A hybrid connector comprising:
a front housing including a fiber connector, wherein the fiber connector is configured to be installed into a first side fiber receptacle of a hybrid adapter to optically couple to an opposite side fiber connector installed into a second side fiber receptacle of the hybrid adapter;
a mid housing including a power plug, wherein the power plug is configured to be installed into a first side power receptacle of an electrical adapter included in the hybrid adapter to electrically couple to an opposite side power plug installed into a second side power receptacle of the electrical adapter included in the hybrid adapter; and
a boot.

10. The hybrid connector of claim 9, wherein the electrical adapter is removably attached to the hybrid adapter.

11. The hybrid connector of claim 9, wherein the electrical adapter is removably attached to the hybrid adapter via a snap-fit mechanism.

12. The hybrid connector of claim 9, wherein the electrical adapter is removably attached to the hybrid adapter via a push-pull clip mechanism.

13. The hybrid connector of claim 9, the electrical adapter further comprising:
a double-sided pin contact plug.

14. The hybrid connector of claim 9, the power plug including a first crimp receptacle contact.

15. The hybrid connector of claim 9, wherein the fiber connector is configured to include one of an LC, CS, MPO, SN, SC, or ST fiber connector form factor.
